(19) United States
(12) Patent Application Publication
(10) Pub. No.: US 2025/0348927 A1
(43) Pub. Date: Nov. 13, 2025

(54) SYSTEMS AND METHODS FOR FACILITATING VEHICLE RECOVERY SERVICES AND OTHER DEMANDED SERVICES

(71) Applicant: C2J Digital LLC d/b/a DIGITOW, Greenwood, IN (US)

(72) Inventors: Craig Blow, Greenwood, IN (US); Joseph Fuqua, Ft. Mill, SC (US); Charles Donly, Temple, TX (US)

(73) Assignee: C2J Digital LLC d/b/a DIGITOW, Greenwood, IN (US)

(21) Appl. No.: 19/202,752

(22) Filed: May 8, 2025

Related U.S. Application Data
(60) Provisional application No. 63/643,986, filed on May 8, 2024.

(51) Int. Cl. G06Q 30/08; G06Q 10/0631; G06Q 10/20

(52) U.S. Cl. CPC G06Q 30/08; G06Q 10/06315; G06Q 10/20

(57) ABSTRACT

Systems and methods for facilitating vehicle recovery services and other demanded services. An exemplary system, accessible by one or more remote users via a network, is configured to perform various steps of a method based upon execution of software instructions using a processor, said method steps including providing an electronic platform accessible by one or more remote users, the electronic platform configured to include data relating to one or more demand users and one or more supply users, entering information relating to a new demand into the electronic platform by a new demand user, the new demand relating to a demanded service, contacting one or more of the one or more supply users via text message from the electronic platform, and confirming demanded service in connection with the new demand using the electronic platform.

### PRIORITY

The present application is related to, and claims the priority benefit of, U.S. provisional patent application Ser. No. 63/643,986 filed May 8, 2024, the contents of which are hereby incorporated herein directly and by reference in their entirety.

### BACKGROUND

Despite the best efforts of companies with fleet vehicles to stay on schedule with routine, scheduled maintenance, vehicles can breakdown, requiring a tow; vehicles get stuck in snow and ice, and in gravel or mud, in and around customers' properties, requiring roadside service. Keys break, drivers get locked out of their vehicles and stranded in myriad ways.

When drivers get stuck on the road, they are not conducting the operations they get paid for, and the company is losing money because it is no longer generating revenue with that vehicular asset. Roadside incidents delay the driver by at least an hour on average. When straddled with these hurdles, incidents take dispatchers' attention away from managing their standard operations typically from 15 to 30 minutes. When dispatchers focus their time on a roadside emergency, other drivers', operators', and customers' needs are put at risk of getting resolved efficiently and effectively. Dispatchers spend time deciding which tow companies might be best to respond to the specific incident, in the location where the driver is stranded. The leaders then must call down a list of tow and roadside service providers to find the first one available who has an “acceptable” estimated time of arrival (ETA) and cost. Then, dispatchers are required to coordinate the tow truck with the company driver, which again creates another friction point and is a poor use of time.

Dispatchers have no way to know how competitive this information is without continuing to call down that list of providers who they have been able to find on their own. Despite establishing pre-negotiated rates with certain roadside providers, they still are not always reliable and it is assumed their rates are competitive with each incident. Corporate fleet owners know that they pay a higher price just to shorten the time spent and burden of calling down the list to reach a tow company willing to complete the service.

Companies also use service providers such as AAA on a corporate level. At times, these services proved unreliable and cost prohibitive. Due to turnover of drivers, too much money was spent re-purchasing memberships for new drivers, and because service providers like AAA do not provide tow companies with a fair market rate, customers would get shifted to lower prioritization, and at times experience even longer wait times to get serviced. Many times, even, no tow providers would respond and AAA would tell the corporate fleet owner to find the service provider on its own. Corporate fleet owners routinely find ourselves back in the same position as if they did not have this service and membership fees.

The vehicle recovery services industry plays a vital role in the transportation sector, providing essential assistance to vehicle owners facing a wide range of challenges, such as breakdowns, accidents, parking violations, and more. Despite its crucial importance, the industry is plagued by inefficiencies, lack of transparency, and customer dissatisfaction. The current process of requesting and dispatching vehicle recovery services is often marked by numerous pain points for both customers and service providers, resulting in operational delays, inconsistent pricing, and a lack of trust in the marketplace.

From the perspective of a stranded motorist, finding and engaging a reliable vehicle recovery service can be a frustrating and time-consuming ordeal. When a vehicle breaks down or needs to be transported, customers often have to contact multiple service providers to inquire about availability, pricing, and estimated response times. This process can be incredibly stressful, particularly in urgent situations where every minute feels like an eternity. Customers may find themselves spending a significant amount of time on the phone, repeating their predicament to multiple operators, and anxiously awaiting callbacks or confirmation. This inefficient process not only prolongs the time it takes to receive assistance but also exacerbates the anxiety and helplessness experienced by customers who are already in distress.

Furthermore, customers often encounter a glaring lack of transparency when it comes to pricing in the vehicle recovery services industry. Without a standardized pricing structure or a platform to compare rates, customers are vulnerable to overcharging or hidden fees. The absence of clear and accessible pricing information erodes trust in the industry and leaves customers feeling taken advantage of in their time of need. Moreover, customers have limited means to assess the reputation and reliability of service providers, making it difficult to make informed decisions when selecting a company to entrust with their vehicle and personal safety.

On the flip side, vehicle recovery service providers face their own set of challenges in the current market landscape. One of the most significant hurdles is the difficulty in efficiently reaching potential customers. Service providers typically rely on traditional marketing channels, such as local advertising or word-of-mouth referrals, to generate business. However, these methods have limited effectiveness in connecting service providers with customers who are in immediate need of their services. As a result, service providers may miss out on potential business opportunities simply because they lack visibility at the critical moment when a customer is searching for assistance.

Moreover, the fragmented nature of the vehicle recovery services industry and the absence of a centralized digital marketplace create an uneven playing field for service providers. Without a platform that enables service providers to compete for jobs and showcase their capabilities, smaller or newer companies may find it challenging to gain a foothold in the market. This lack of exposure and opportunity can hinder the growth and success of service providers, limiting their ability to expand their customer base and increase revenue.

The absence of a unified, technology-driven solution in the vehicle recovery services industry perpetuates inefficiencies, customer frustration, and a disjointed market. There is an urgent need for a digital marketplace that tackles these challenges head-on by providing a seamless platform that connects customers with service providers, ensures fair and transparent pricing, and optimizes response times. Such a platform would revolutionize the industry by introducing much-needed transparency, convenience, and trust, ultimately benefiting both customers and service providers.

### BRIEF SUMMARY

The present disclosure includes disclosure designed to simplify this stressful process for customers—which includes but not limited to companies, private owners, insurance providers, and others. Drivers and the dispatchers (when applicable) when using DigiTow, can quickly return to focus on the tasks they major in, and get back to their lives and also serving the community with their businesses, and earning revenues for their companies. Systems and methods of the present disclosure can reduce the cost of roadside service, routinely seeing savings of 50% when comparing the differential between tow companies. There is also a reduction in the time the drivers are stranded not doing their jobs, thus significantly reducing operational costs of down time, and corporate fleet dispatchers save time while reducing their stress and work load by connecting them directly to multiple tow companies simultaneously, and automating the communications between all parties to ensure everyone stays connected and up to date with the recovery each step of the way. Said systems and methods of the present disclosure provide users confidence they will get serviced at the best price, in the fastest time, and the everyone can quickly get back to focusing on their primary tasks at hand.

A digital marketplace for vehicle recovery services, such as disclosed herein, can transform the industry landscape by offering a centralized platform where customers can easily request assistance, compare prices, and view the reputation and availability of service providers. Simultaneously, service providers would have equal opportunities to compete for jobs, showcase their expertise, and expand their customer base. By leveraging cutting-edge technology and data-driven solutions, the digital marketplace would streamline the matching process between customers and service providers, ensuring that customers receive top-notch service at fair prices while service providers can optimize their operations and grow their businesses.

Additionally, a digital marketplace such as disclosed herein would promote transparency and accountability in the vehicle recovery services industry. Customers would gain access to real-time information about pricing, estimated response times, and the service history of providers. This level of transparency would empower customers to make informed decisions and hold service providers accountable for their performance. In turn, service providers would be motivated to deliver exceptional service and maintain a stellar reputation to attract more business through the platform.

The introduction of a digital marketplace for vehicle recovery services would not only address the existing challenges in the industry but also pave the way for innovation and growth. By harnessing advanced technologies, such as mobile applications, GPS tracking, and data analytics, the digital marketplace could offer a range of enhanced features and services to both customers and service providers. For instance, customers could track the real-time location of the service vehicle, receive notifications about the estimated time of arrival, and make secure payments through the platform. Service providers could optimize their routes, efficiently manage their fleet, and gain valuable insights into market trends and customer preferences.

To summarize, the vehicle recovery services industry is ripe for a digital transformation to overcome the chronic challenges of inefficiency, opacity, and customer dissatisfaction. The development of a comprehensive digital marketplace that seamlessly connects customers with service providers, ensures fair and transparent pricing, and optimizes response times is paramount for the future growth and success of the industry. By embracing technological innovation, the vehicle recovery services industry can unlock new opportunities, elevate customer experiences, and drive profitability for service providers. The establishment of such a digital marketplace would not only revolutionize the industry but also contribute to the overall efficiency and reliability of the transportation sector, ultimately making a positive impact on society as a whole.

The present disclosure includes disclosure of a system, accessible by one or more remote users via a network, configured to perform various steps of a method based upon execution of software instructions using a processor, said method steps comprising providing an electronic platform accessible by one or more remote users, the electronic platform configured to include data relating to one or more incident service requesters and one or more recovery service providers, entering information relating to a new incident into the electronic platform by a new service requester, contacting one or more of the one or more recovery service providers via text message from the electronic platform, and confirming recovery services in connection with the new incident using the electronic platform.

The present disclosure includes disclosure of a system, accessible by one or more remote users via a network, configured to perform various steps of a method based upon execution of software instructions using a processor, said method steps comprising providing an electronic platform accessible by one or more remote users, the electronic platform configured to include data relating to one or more incident service requesters and one or more recovery service providers, entering information relating to a new incident into the electronic platform by a new service requester, the incident relating to a vehicle in need of recovery service, contacting one or more of the one or more recovery service providers via text message from the electronic platform, and confirming recovery services in connection with the new incident using the electronic platform.

The present disclosure includes disclosure of a system, wherein the one or more recovery service providers are associated with a region or location, wherein multiple regions or locations are included within the electronic platform.

The present disclosure includes disclosure of a system, wherein the step of confirming recovery services is performed after at least one of the one or more recovery service providers has submitted a bid via text message, said bid appearing within the electronic platform and being accessible by and accepted by the new service requester.

The present disclosure includes disclosure of a system, wherein the step of confirming recovery services is performed after at least one of the one or more recovery service providers has submitted a bid via text message, said bid appearing within the electronic platform and being accessible by the new service requester, whereby the new service requester has submitted a counter bid price, which was accepted by the at least one of the one or more recovery service providers.

The present disclosure includes disclosure of a system, wherein the step of confirming recovery services is performed to alert the new service requester of the availability of a recovery service provider of the one or more recovery service providers.

The present disclosure includes disclosure of a system, wherein the step of contacting is performed automatically based upon the information provided by the new service requester.

The present disclosure includes disclosure of a system, wherein the step of confirming recovery services is first performed by a recovery service provider of the one or more recovery service providers providing a confirmation that recovery service can be performed at a particular price and within a particular period of time.

The present disclosure includes disclosure of a system, wherein the one or more remote users are demand users, and wherein the one or more recovery service providers are supply users.

The present disclosure includes disclosure of a method, comprising operating an exemplary system of the present disclosure to facilitate the recovery services.

The present disclosure includes disclosure of a system, accessible by one or more remote users via a network, configured to perform various steps of a method based upon execution of software instructions using a processor, said method steps comprising providing an electronic platform accessible by one or more remote users, the electronic platform configured to include data relating to one or more demand users and one or more supply users, entering information relating to a new demand into the electronic platform by a new demand user, the new demand relating to a demanded service, contacting one or more of the one or more supply users via text message from the electronic platform, and confirming demanded service in connection with the new demand using the electronic platform.

The present disclosure includes disclosure of a system, wherein the one or more supply users are associated with a region or location, wherein multiple regions or locations are included within the electronic platform.

The present disclosure includes disclosure of a system, wherein the step of confirming demanded services is performed after at least one of the one or more supply users has submitted a bid via text message, said bid appearing within the electronic platform and being accessible by and accepted by the new demand user.

The present disclosure includes disclosure of a system, wherein the step of confirming demanded services is performed after at least one of the one or more supply users has submitted a bid via text message, said bid appearing within the electronic platform and being accessible by the new demand user, whereby the new demand user has submitted a counter bid price, which was accepted by the at least one of the one or more supply users.

The present disclosure includes disclosure of a system, wherein the step of confirming demand services is performed to alert the new demand user of the availability of a supply user of the one or more supply users.

The present disclosure includes disclosure of a system, wherein the step of contacting is performed automatically based upon the information provided by the new demand user.

The present disclosure includes disclosure of a system, wherein the step of confirming demand services is first performed by a supply user of the one or more supply users providing a confirmation that the demanded service can be performed at a particular price and within a particular period of time.

The present disclosure includes disclosure of a method, comprising operating an exemplary system of the present disclosure to facilitate the demanded service.

The present disclosure includes disclosure of a system, wherein the one or more recovery service providers are associated with a region or location, wherein multiple regions or locations are included within the electronic platform.

The present disclosure includes disclosure of a system, wherein the step of confirming recovery services is performed after at least one of the one or more recovery service providers has submitted a bid via text message, said bid appearing within the electronic platform and being accessible by and accepted by the new service requester.

The present disclosure includes disclosure of a system, wherein the step of confirming recovery services is performed after at least one of the one or more recovery service providers has submitted a bid via text message, said bid appearing within the electronic platform and being accessible by the new service requester, whereby the new service requester has submitted a counter bid price, which was accepted by the at least one of the one or more recovery service providers.

The present disclosure includes disclosure of a system, as described or otherwise disclosed or shown herein.

The present disclosure includes disclosure of a method, comprising one or more steps as described or otherwise disclosed or shown herein.

The present disclosure includes disclosure of a system, comprising a dashboard screen, a current incidents screen, a new incident screen, a bids screen; and a messages screen.

The present disclosure includes disclosure of a system, accessible by one or more remote users via a network, configured to perform various steps of a method based upon execution of software instructions using a processor, said method steps comprising providing an electronic platform accessible by one or more remote users, the electronic platform configured to include data relating to one or more demand users and one or more supply users, entering information relating to a new demand into the electronic platform by a new demand user, contacting one or more of the one or more supply users via text message from the electronic platform, and confirming demand services in connection with the new demand using the electronic platform.

The present disclosure includes disclosure of a system, wherein the one or more supply users are associated with a region or location, wherein multiple regions or locations are included within the electronic platform.

The present disclosure includes disclosure of a system, wherein the step of confirming demand services is performed after at least one of the one or more supply users has submitted a bid via text message, said bid appearing within the electronic platform and being accessible by and accepted by the new demand user.

The present disclosure includes disclosure of a system, wherein the step of confirming demand services is performed after at least one of the one or more supply users has submitted a bid via text message, said bid appearing within the electronic platform and being accessible by the new demand user, whereby the new demand user has submitted a counter bid price, which was accepted by the at least one of the one or more supply users.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1 shows a dashboard screen, according to an exemplary embodiment of the present disclosure;

FIG. 2 shows a current incidents screen, according to an exemplary embodiment of the present disclosure;

FIG. 3 shows a new incidents screen, according to an exemplary embodiment of the present disclosure;

FIG. 4 shows a new incidents screen, according to an exemplary embodiment of the present disclosure;

FIG. 5 shows a bids screen, according to an exemplary embodiment of the present disclosure;

FIG. 6 shows a messages screen, according to an exemplary embodiment of the present disclosure;

FIG. 7 shows a counter-offer window according to an exemplary embodiment of the present disclosure;

FIG. 8 shows a current incidents screen, according to an exemplary embodiment of the present disclosure;

FIG. 9 shows a detailed incidents screen, according to an exemplary embodiment of the present disclosure;

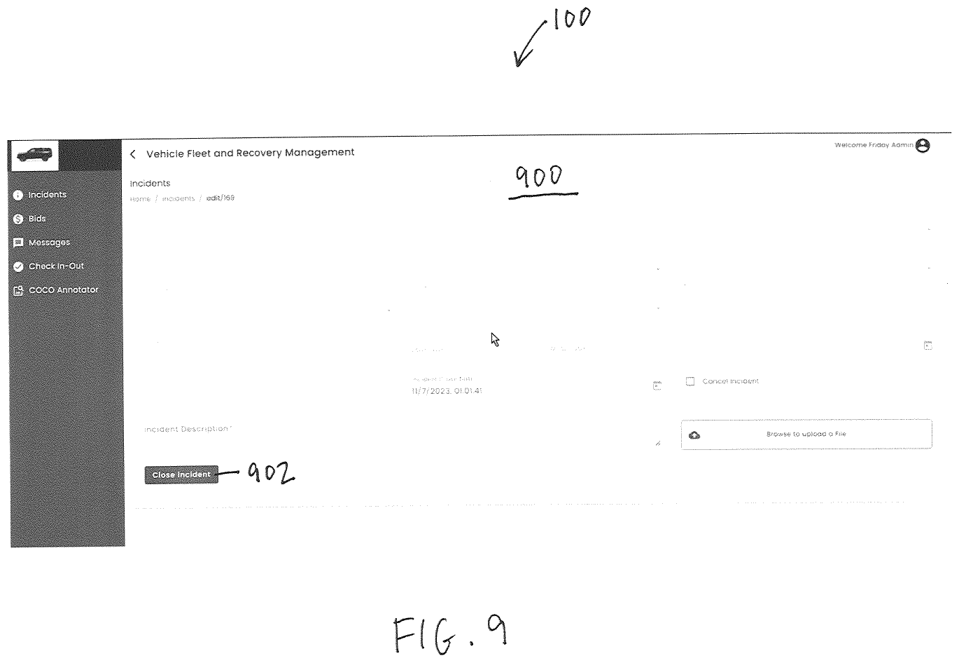

FIG. 10 shows a diagram of a system accessible by users directly or via a network, according to an exemplary embodiment of the present disclosure; and

FIG. 11 shows elements of a method of using a system, according to an exemplary embodiment of the present disclosure.

As such, an overview of the features, functions and/or configurations of the components depicted in the various figures will now be presented. It should be appreciated that not all of the features of the components of the figures are necessarily described and some of these non-discussed features (as well as discussed features) are inherent from the figures themselves. Other non-discussed features may be inherent in component geometry and/or configuration. Furthermore, wherever feasible and convenient, like reference numerals are used in the figures and the description to refer to the same or like parts or steps. The figures are in a simplified form and not to precise scale.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The present disclosure includes disclosure of a novel approach for an independent business (and other customers) to eliminate the trade-off between needing to quickly get their vehicle back on the road after a breakdown and earning money with eliminating the current inefficiencies and navigating the opaque market a business needs to make to secure a reasonable and fair service among a distributed network of vehicle recovery providers.

The disclosure provided herein can be generalized for any marketplace where pricing is real-time, not readily available, not aggregated, and a customer's need is urgent.

As note in further detail herein, the present disclosure includes disclosure of specific novel solutions to eliminate this trade-off with features such as:
Verification of vehicle and situation (the technology provides for a more accurate estimation of cost, time and resources to bid on the work than existing solutions today)
Real-time value/cost estimation (solutions today increase costs and deprive providers of full revenue because match-making solutions become the provider with static contracts)
Existing technology (text) based extension of solution (meeting the industry requirements for usability and low tolerance for training a transient workforce)
Bidding and business automation (1-way blind bidding to entice bidders but ensure real-time fair market value)
Potential for predictive analytics for industry efficiency (similar to what the Black-Sholes equation did for the stock market)

The present disclosure includes disclosure of systems and methods, such as those embodied in the DigiTow systems and methods described herein, which is a groundbreaking digital marketplace that revolutionizes the vehicle recovery services industry by providing a seamless, efficient, and transparent platform connecting fleet vehicle operators with regionally focused service companies. By harnessing the power of short messaging services (SMS)/text communication, DigiTow streamlines the process of requesting and dispatching vehicle recovery services, benefiting both fleet operators and service providers.

A core functionality of DigiTow lies in its innovative bidding system, which allows customers, whether fleet managers, operators or private drivers, to submit a request for assistance to a pool of service companies simultaneously using a web-based application that communicates with participants via SMS/text. This approach eliminates the need for time-consuming phone calls and manual outreach to individual providers. Upon receiving the request, service companies in the relevant geographic area can quickly assess the details of the service call and submit competitive bids by responding directly to the text, which is processed by the DigiTow platform.

In at least one embodiment, and when a user makes a request through the system/platform for service, that request is managed by an individual who can then facilitate obtaining bids from service providers and sharing said bids with the user who made the request. In at least another embodiment, and when a user makes a request through the system/platform for service, that request is managed automatically using a predictive analytics engine that can select and present the best real-time service options to the requesting user. Such an embodiment would expand the potential market of clients to anyone who does not have a fully staffed company and includes the general public.

One of the key advantages of DigiTow's bidding process is that it empowers customers to make informed decisions based on a combination of factors, including price, estimated time of arrival, and the service provider's reputation. The customer can review the submitted bids and select the most appropriate offer based on their specific needs and priorities. This level of transparency and control ensures that fleet operators receive the best possible service at a fair price, ultimately reducing downtime and maximizing operational efficiency.

Furthermore, DigiTow's bidding system introduces a unique feature that sets it apart from traditional dispatching methods: the ability for customers to counter-bid an offer. If the customer feels that a particular bid doesn't fully meet their requirements or if they believe there is room for negotiation, they can initiate a counter-bid. This feature promotes a dynamic and competitive marketplace, encouraging service providers to offer their best rates and services to secure the job. In at least one embodiment of the present disclosure, the system can use machine learning or Artificial Intelligence (AI) to parse the response/information from the service provider to categorize the cost and estimated time of arrival (ETA) from the service provider's natural-language response. The counter-bidding process fosters a more collaborative relationship between customers and service providers, ensuring that both parties can reach a mutually beneficial agreement.

Once a bid is accepted, DigiTow automatically notifies the selected service company, providing them with all the necessary details to promptly proceed to the vehicle in need of assistance. This automated notification system eliminates communication gaps and ensures that service providers can respond swiftly to the fleet operator's request. By minimizing delays and streamlining the dispatching process, DigiTow helps fleet operators get their vehicles back on the road as quickly as possible, reducing downtime and maintaining operational continuity.

DigiTow's system and SMS/text-based communication platform offers several advantages over traditional phone-based dispatching. Firstly, it provides a clear and concise record of all interactions between fleet operators and service providers. This digital trail can be invaluable for auditing purposes, dispute resolution, and performance tracking. Secondly, SMS/text communication allows for quick and efficient information sharing, enabling service providers to receive accurate details about the vehicle's location, condition, and specific requirements. This level of detail ensures that service providers arrive at the scene well-prepared and equipped to handle the situation effectively.

Moreover, DigiTow's focus on regionally focused service companies brings a new level of efficiency and expertise to the vehicle recovery services industry by partnering with local and regional providers who have intimate knowledge of the area's roads, traffic patterns, and unique challenges.

In addition to its core bidding and dispatching functionality, DigiTow can offer a range of value-added features that further enhance the user experience for both fleet operators and service providers. These features may include real-time GPS tracking of service vehicles, allowing fleet operators to monitor the progress of the recovery process and provide accurate ETAs to their own customers. DigiTow may also offer a rating and review system, enabling fleet operators to provide feedback on the quality of service received and helping other users make informed decisions when selecting a service provider.

The development of DigiTow represents a significant step forward in the digitization and optimization of the vehicle recovery services industry. By leveraging the power of SMS/text communication, a transparent bidding system, and regional expertise, DigiTow streamlines the entire process of requesting and dispatching vehicle recovery services. Fleet operators benefit from increased efficiency, cost savings, and the ability to make informed decisions based on real-time data. Service providers, in turn, gain access to a larger pool of potential customers, can compete fairly for jobs, and have the opportunity to showcase their expertise and build their reputation in the market.

In summary, DigiTow is a game-changing digital marketplace that addresses the long-standing challenges faced by the vehicle recovery services industry, focused on maximizing customer experience and economics. By providing a seamless, transparent, and efficient platform that connects customers with regionally focused service companies, DigiTow sets a new standard for how vehicle recovery services are requested, dispatched, and delivered. As the industry continues to evolve and embrace digital transformation, DigiTow is well-positioned to lead the way in revolutionizing the way fleet operators and service providers interact, ultimately driving efficiency, cost savings, and improved customer satisfaction.

Systems and method of the present disclosure include several novel value propositions, such as:
1. Verification of vehicle and situation
   a. Offering image sharing with vehicle recovery providers (which doesn't exist on other platforms). Tow providers can more accurately:
      i. estimate cost,
      ii. verify the vehicle, and
      iii. verify type of service and equipment needed.
   b. Improved safety at point of recovery and service by confirming identity against digitally provided information.
      i. This can further be accomplished thru generating a code for the winning bidder and sharing it between driver and winning bidder and deterring vehicle recovery companies that may circumvent and violate terms of service that could result in an unsafe situation.
2. Real-time value/cost estimation:
   a. Existing solutions depend on provider contracts
   b. Provider of vehicle recovery service has to share revenue or is limited by existing contract under existing solutions.
3. Existing technology (text message) based extension of solution:
   a. negates the need to train drivers and vehicle recovery providers
      i. In an independent business, drivers training can be inefficient compared to the industry standard tenure of a driver.
   b. Extendable to individual users where the barrier to entry and use needs to have a simple and “no-training” solution.
   c. For the vehicle recovery provider, no additional information technology (IT) requirement, or need to add or manage technology in their business.
4. Bidding and business automation
   a. Many private drivers and dispatchers in independent businesses don't have training, processes or automation to complete their work.
   b. 90% reduction in non-value-added time by automating communication between all three groups (driver, dispatcher, bidding vehicle recovery services)
   c. Automated extraction of price and time from bidder's text messages
   d. Automated counter-bidding and bid acceptance.
   e. Customization of bidding process. Select vehicle recovery provider by distance or region and also filter by specific company.
   f. Provide transparent and real-time savings for service based on active bids by real providers and not projections or static tables.
   g. Set up a one-way transparency which is blind between service providers and creates an environment to propose the real price as judged by each provider without influence. (compared to a fully transparent bidding market where other providers can influence lower or higher bids artificially compared to market needs).
5. Potential for predictive analytics
   a. Digital bidding and incident solution offers first in industry data driven prediction of future costs and time to service for both users and providers of fleet recover service.
      i. Data-structure supports regional and customized prediction of costs including factors such as seasonality.
      ii. Machine Learning capability to identify anomalous bidding, artificial inflation of prices, monopolistic behavior by region, and potentially illegal collusion by vehicle recovery providers.

The present disclosure includes disclosure of a system and method for facilitating vehicle recovery services by a recovery service provider as requested by a user, utilizing inputs from a computer-based system and via text message.

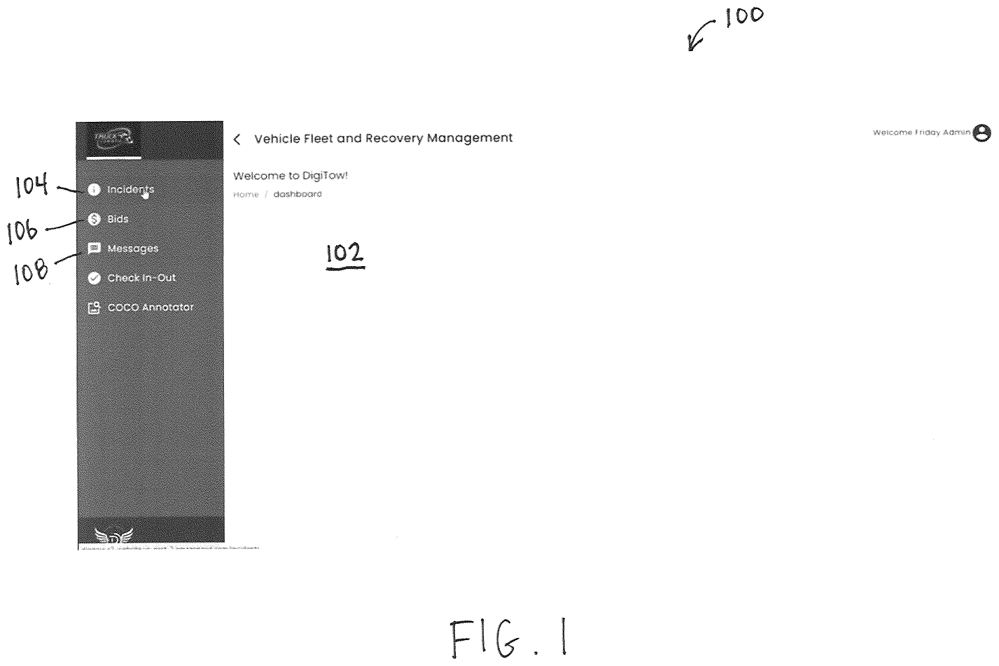

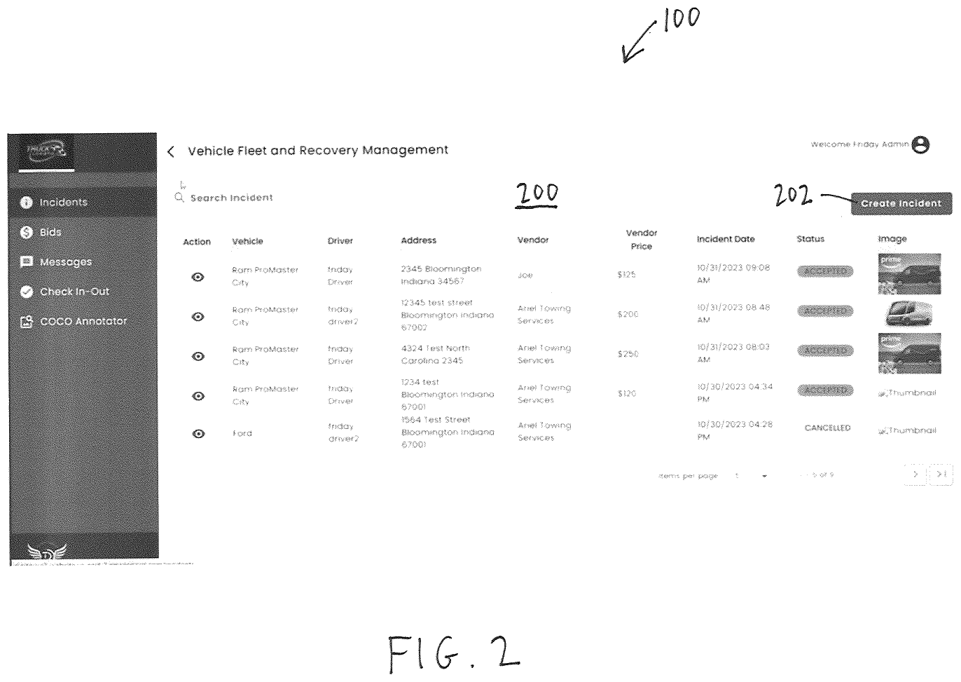

In at least one embodiment, a system 100 (providing an electronic platform) of the present disclosure comprises a dashboard screen 102, such as shown in FIG. 1, which may include at least an incidents selection 104 and a bids selection 106. Selecting the incidents selection 104 leads a user to a current incidents screen 200 or portion thereof, such as shown in FIG. 2 identifying any potential current incidents, such as those indicating the type of vehicle, driver name, address, the recovery service vendor name, the vendor price (if said price was accepted), the date and time of the incident, the status of the incident (such as being “accepted” or “cancelled” or “pending,” for example), and optionally a thumbnail version of the image of the vehicle requiring service.

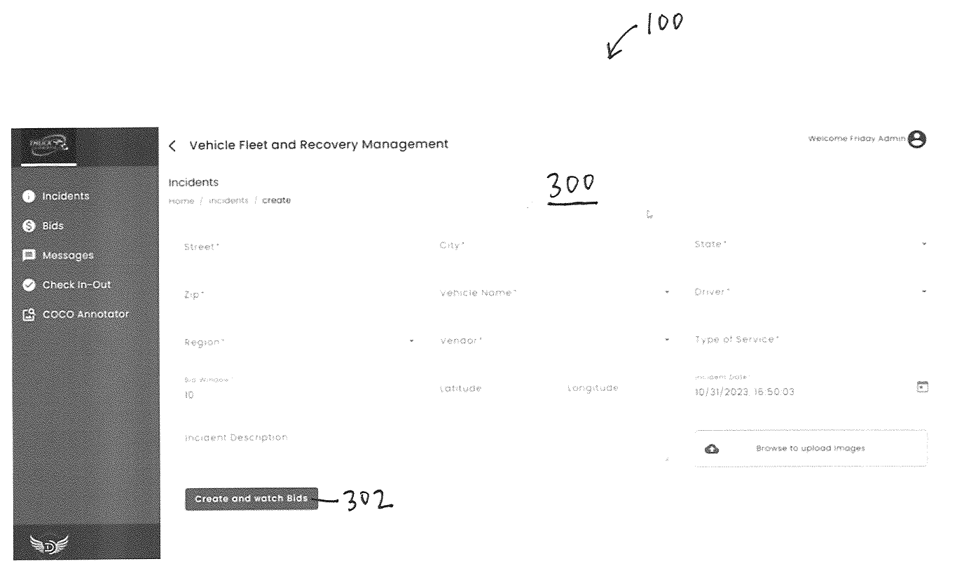

Current incidents screen 200, as shown in FIG. 2, may comprise a create incident button 202, whereby when selected opens a new incident screen 300, such as shown in FIG. 3, for creating a new incident, whereby the user can enter information relating to the vehicle requiring towing service (recovery service), the address for the location, the driver name, the type of service required, etc.

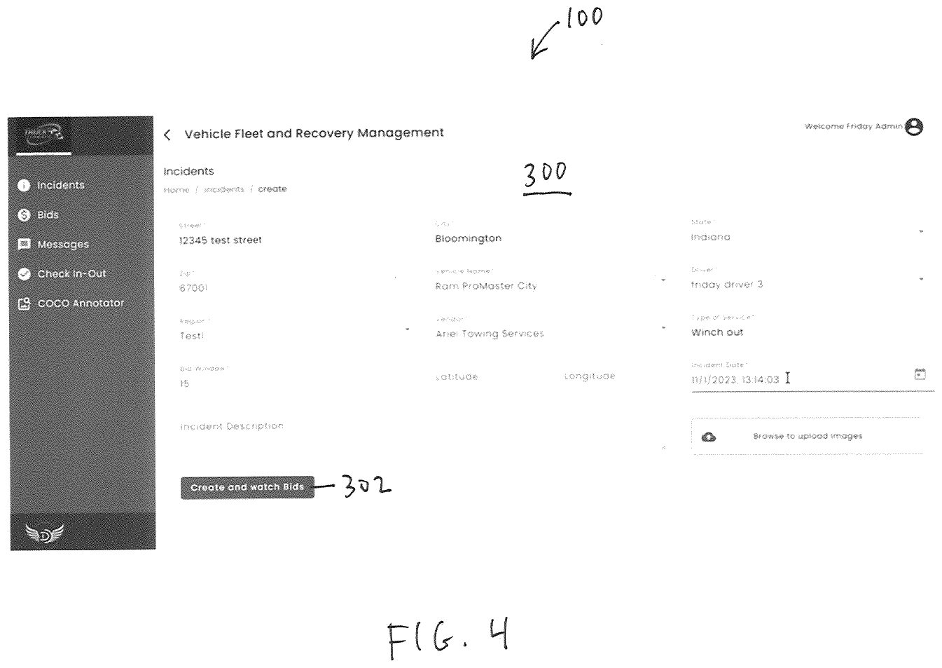

FIG. 4 shows a new incident screen 300 with information relating thereto entered therein. For the “Region” section of the new incident screen 300, one or more preselected regions (such as including Bloomington, Martinsville, Greenwood, etc., being cities in Indiana, for example) can be chosen, and once chosen, the “Vendor” section populates with participating vendors in the chosen region. One or more participating vendors can then be chosen to ultimately provide recovery service. The type of service can be identified (such as winch service, towing, etc.), and a description of the incident can be provided as well. One or more images can also be included with the new incident screen 300.

After the relevant information has been entered into and/or selected within new incident screen 300, a user can select a “create and watch bids” button 302 or similar button to create and monitor bids with respect to the present incident. Selecting said button 302 triggers the incident, and system 100 contacts the one or more participating vendors in the region via text message and/or via a smartphone application with information relative to the present incident.

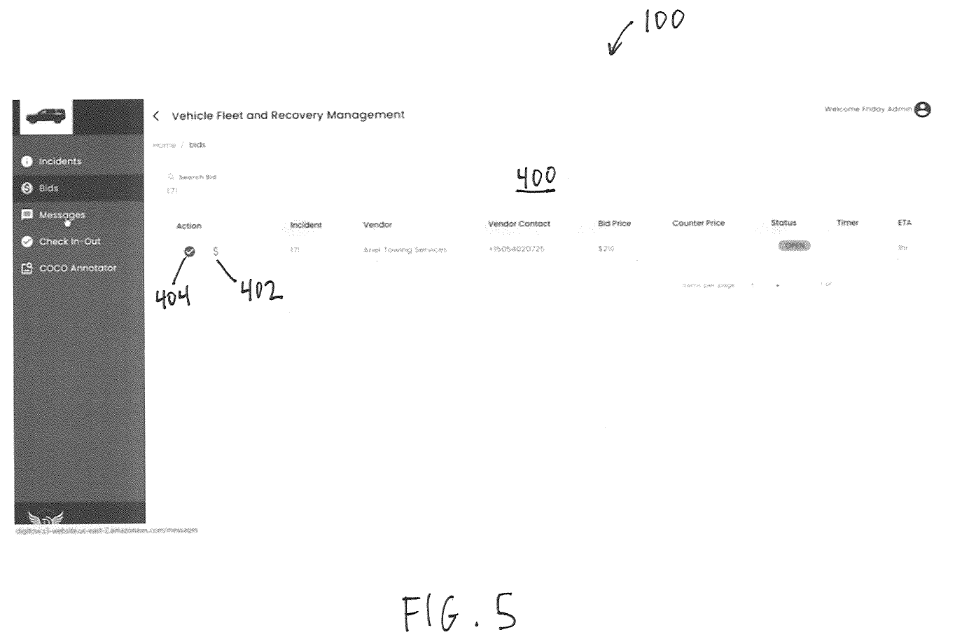

The system may then direct the user to a bids screen 400, such as shown in FIG. 5, and/or a user can select the bids selection 106 from dashboard screen 102 to get to the bids screen 400. Bids screen 400 can provide information regarding the incident, including the name of a bidding vendor, contact information for said vendor, and their bid price to provide the service. A status, timer, and estimated time of arrival (ETA) can be provided as well, such as when or if a bid is ultimately accepted. For example, and as shown in FIG. 5, an exemplary bids screen 400 can include the bid price (here $210) and the ETA (here 1 hr), corresponding to a vendor's responsive text message of “$210 1 hr” or similar. System 100 identifies the dollar amount and the ETA/time from the responsive text message and populates the same in bids screen 400, along with the name and contact information of the bidding vendor.

Once the requisite information has been added (effectively creating an “incident”), a user may then submit the information so that the system 100 can take that information and share it with potential recovery service companies. Said companies can then bid for the service, providing details in connection with the bid (bid price, service timing, type of service vehicle, and the like). That information would then populate part of a bid screen 400, with information regarding the bid being identified thereon (such as the name of the service company, bid price, service timing, type of service vehicle, and the like).

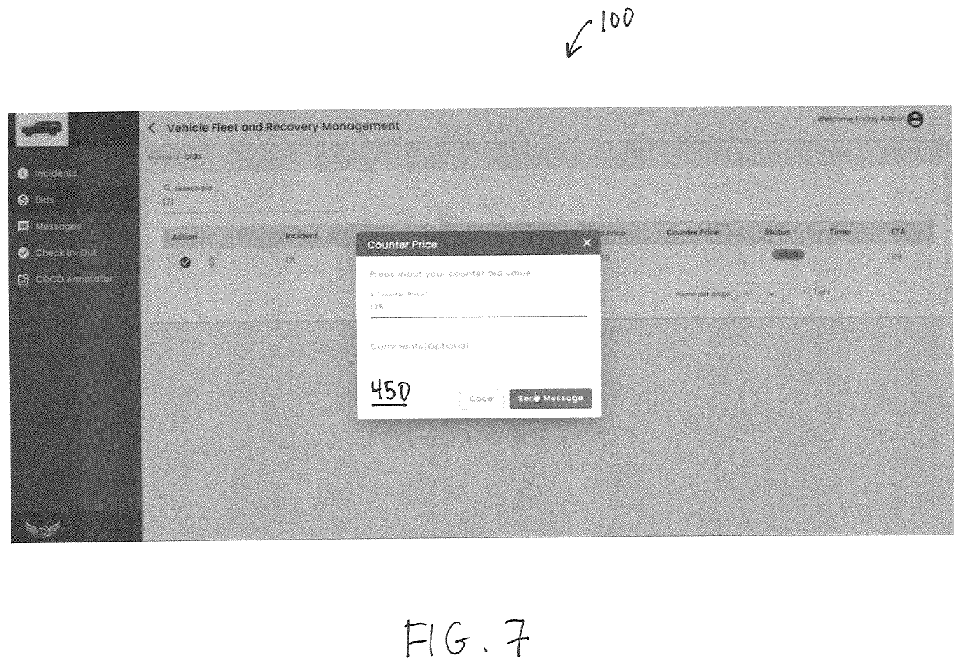

Should the user of system 100 wish to accept the bid from the recovery service vendor, the user can click the accept button 404 (such as identified by a checkmark or otherwise). If the user wishes to provide a counteroffer, a counteroffer button 402 (such as identified by a dollar sign or otherwise) can be selected, which opens a window (counteroffer window 450, such as shown in FIG. 7) where the user can submit a counteroffer back to the bidding recovery service vendor.

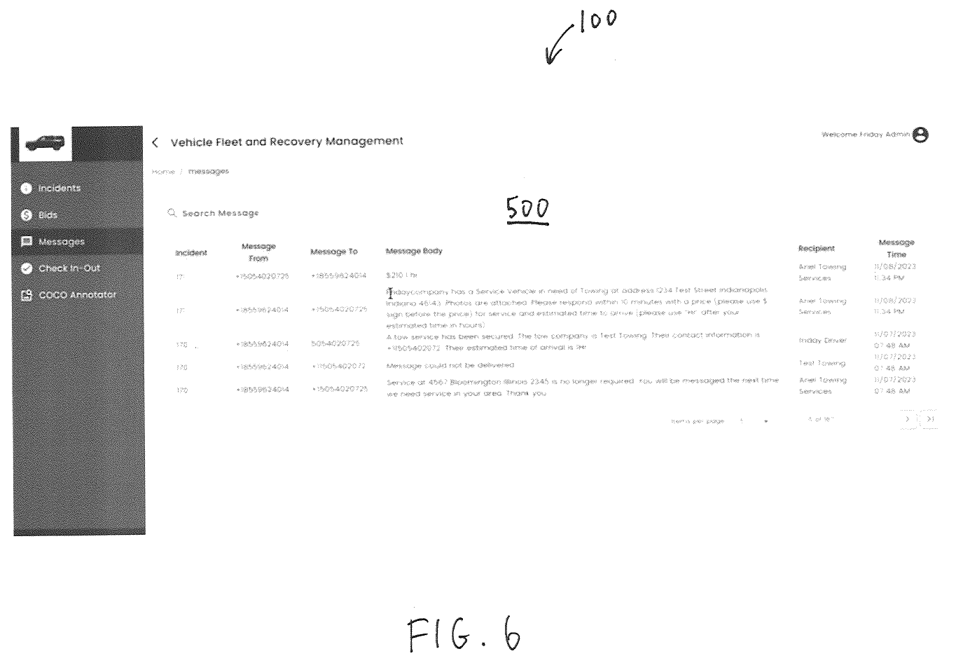

Messages can be reviewed by selecting messages selection 108 from dashboard screen. Messages then populate a messages screen 500, identified by incident, phone numbers from and to in connection with the message, the message body, the recipient of the message, and the date and time of the message can all be captured therein, such as shown in FIG. 6. In the event a counteroffer for a bid is made, the messages screen is updated with a message indicating acceptance and/or other information.

If a bid is ultimately accepted, a status of “accepted” can be shown on the bid screen 400. In at least one embodiment, an automated message identifying acceptance of the bid would be sent via text message or smartphone application to the bidding vendor. An automated message may also be sent to other bidding vendors that a bid has been accepted from another vendor for said incident.

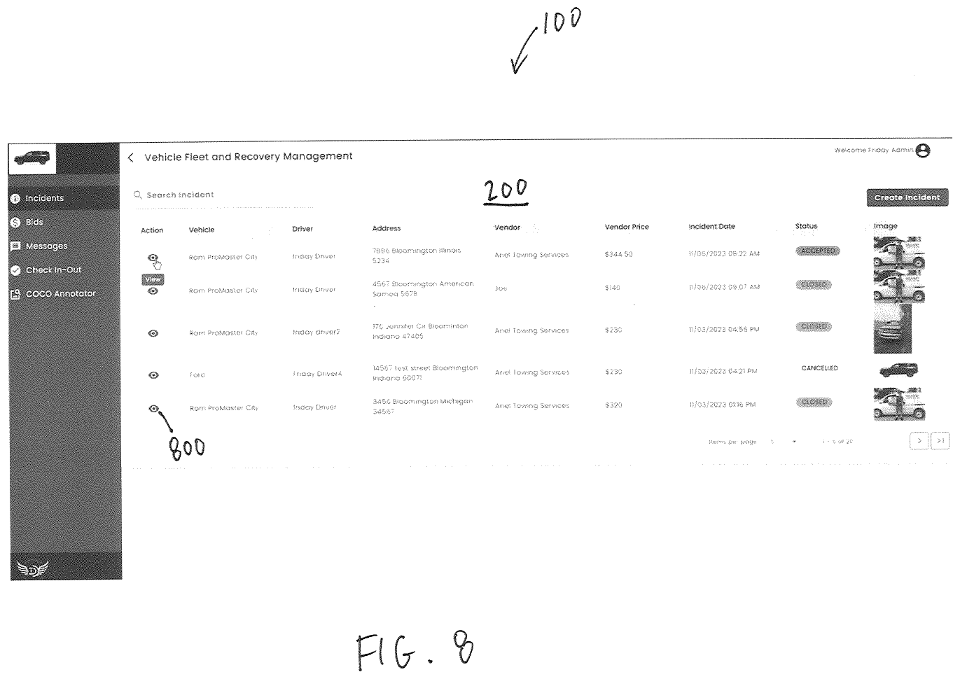

FIG. 8 shows a version of a current incidents screen 200 of the present disclosure. As shown therein, there are multiple “Status” options, such as “accepted,” “closed,” and “cancelled.” To view details of an incident, a user can select view incident button 800 (such as identified by an eye or otherwise), which will then populate a detailed incidents screen 900, which may contain the same information and/or otherwise mirror new incident screen 300. Selecting the “close incident” button 902 would then close the incident, and the status of the incident would be updated from “accepted” or otherwise to “closed.” In the event a pending incident is to be cancelled, a user can select the “cancel incident” button 904, which would then close the incident, and the status of the incident would be updated from “accepted” or otherwise to “cancelled,” such as due to a recovery service provider cancelling or otherwise not appearing to provide service. A “closed” incident, for example, would be indicative of a successful service being provided by a vendor.

Systems 100 of the present disclosure can also be used in connection with reporting claims for insurance purposes. As such, insurers (insurance companies or insurance brokers) can also be involved in the process by way of providing insurance service to the users requesting recovery services. As such, systems 100 of the present disclosure can also be used to identify an insurer as being applicable to a user requesting recovery services, submit a claim for reimbursement, and monitor receipt of payment from said insurer.

Systems 100 of the present disclosure can also be used to market services to a driver of a vehicle, such as a vehicle that may be in need of recovery services at that time or some time in the future. For example, when using the system 100 in an “app” form on a smartphone, a driver user may receive advertisements from any number of product and/or service providers, such as insurance providers.

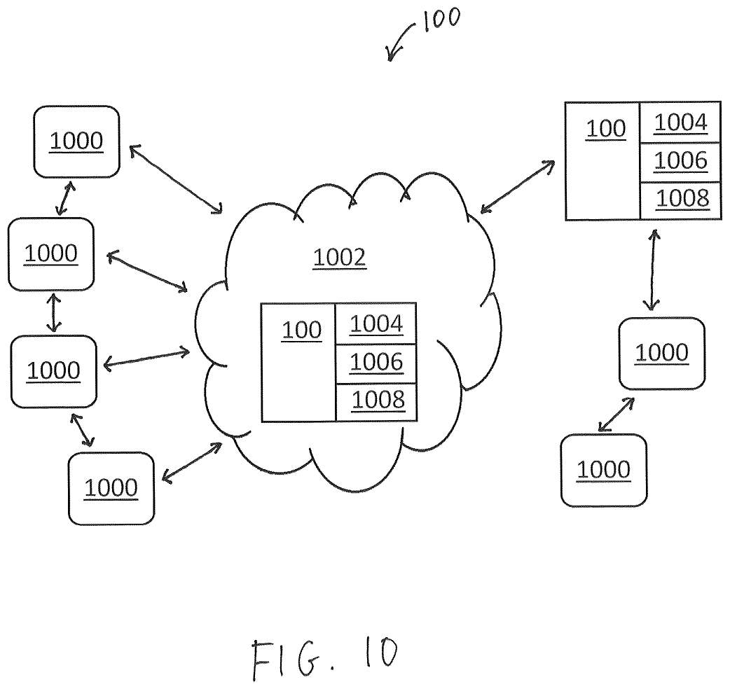

Systems 100 of the present disclosure are generally computer and text message-based systems, whereby users and vendors can access the system and communicate therewith either by computer usage (such as via a website), smart phone usage (such as via the use of an application (or “app”)), tablet usage, and/or via a device facilitating text messages. A general diagram is shown in FIG. 10, whereby one or more users 1000 (incident submitters, recovery service providers, insurers, administrators, etc.) can communicate via a network 1002 (internet, cellular network, etc.) with one another via and with system 100. System 100 can comprise software 1004 housed on a computer (such as within a computer memory 1006) either provided locally or remotely or within a network or cloud. One or more processors 1008 in communication with the computer memory 1006 are then operable to perform instructions from software 1004 to perform various steps in the system 100 processes noted above. It is further noted that said users 1000 can be users 1000 using computers, smart phones, other cellular telephones, tablets, and the like, to communicate with system 100. Systems 100 of the present disclosure are generally referred to herein as being accessible by one or more remote users 1000 via a network 1002, configured to perform various steps of a method based upon execution of software 1004 instructions using a processor 1008. Systems 100 may also refer to a computer having software 1004 stored within a memory 1006, accessible by way of a processor 1008, noting that user 1000 computers, smartphones, other cellular telephones, tablets, and the like, may also comprise software 1004 stored within a memory 1006, accessible by way of a processor 1008 to communicate and/or otherwise interact with system 100, either directly with one another or indirectly through a network 1002.

Systems 100 of the present disclosure can be monetized in several respects, such as by requiring a fee to be paid by users 1000 of the system, such as by companies with fleets of vehicles potentially requiring recovery services, and the like.

More generically, systems 100 of the present disclosure involve various types of users 1000, such as users 1000 requesting and requiring services, service providers, and system 100 administrators who facilitate general use of said systems 100. In at least some embodiments, users 1000 requesting and requiring services would pay a fee for participating in using said system 100 (the demand users 1000), and service providers (the supply users 1000) would be confirmed by system 100 administrators so that they could ultimately provide services to the demand users 1000. Systems 100 of the present disclosure therefore provide access to service providers, whereby buyers (the demand users 1000) have direct access to the supply users 1000 without paying in advance, with savings shared with the broker (system 100 administrators). Systems 100 of the present disclosure therefore offer a repeatable process, which otherwise currently is not part of the vehicle recovery system business model, whereby various automated processes, such as best practices like handling non-winners, security code confirmations for the winner, better information for real-time pricing, etc., are included therein. Time savings and a reduced non-value-added cost on both sides are also benefits of systems 100 of the present disclosure, namely as suppliers do not need to advertise, and buyers (demand users 1000) get to choose their real-time provider at the then-current price. Any number of different types of services can be provided to demand users 1000 in demand for said services.

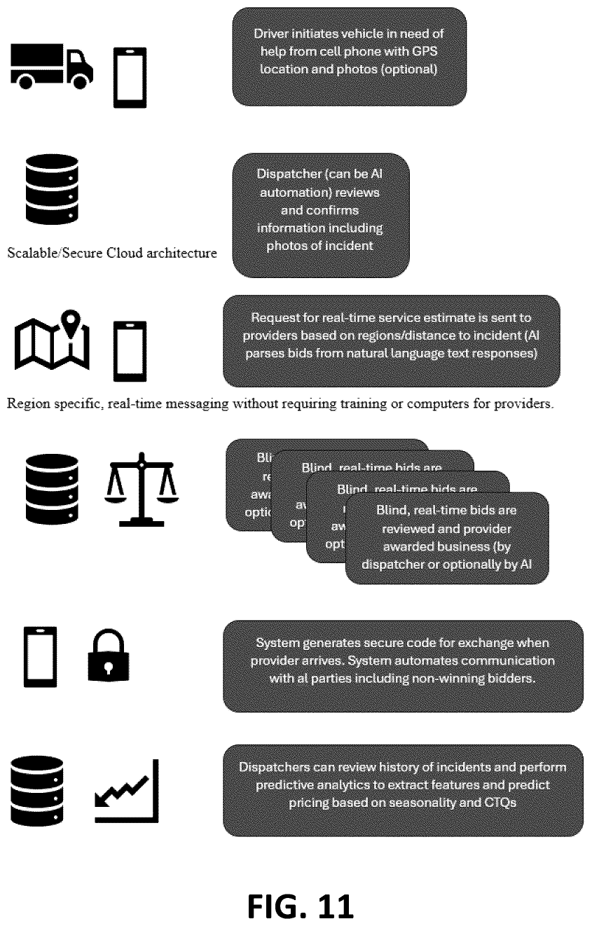

FIG. 11 shows elements/steps of an exemplary method of using a system 100 of the present disclosure. As shown therein, a driver can initiate a vehicle in need of help from a cell phone with GPS location and photos (optional). A dispatcher, which can be artificial intelligence (AI) automation, reviews the inquiry and confirms information including photos of the incident, which can be scalable and a secure cloud architecture. A request for real-time service estimate is sent to providers based on regions/distance to the incident, whereby, for example, an AI parses the bids from the natural language text response. This is region specific, real-time messaging without requiring training or computers for providers. Blind, real-time bids can then be reviewed and a provider can be awarded the business, by a dispatcher or optionally using AI. Dispatchers can review the history of incidents and perform predictive analytics to extract features and predict pricing based on seasonality and critical to quality characteristics (CTQs).

While various embodiments of systems and methods for using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A system, accessible by one or more remote users via a network, configured to perform various steps of a method based upon execution of software instructions using a processor, said method steps comprising:
providing an electronic platform accessible by one or more remote users, the electronic platform configured to include data relating to one or more incident service requesters and one or more recovery service providers;
entering information relating to a new incident into the electronic platform by a new service requester, the incident relating to a vehicle in need of recovery service;
contacting one or more of the one or more recovery service providers via text message from the electronic platform; and
confirming recovery services in connection with the new incident using the electronic platform.

2. The system of claim 1, wherein the one or more recovery service providers are associated with a region or location, wherein multiple regions or locations are included within the electronic platform.

3. The system of claim 1, wherein the step of confirming recovery services is performed after at least one of the one or more recovery service providers has submitted a bid via text message, said bid appearing within the electronic platform and being accessible by and accepted by the new service requester.

4. The system of claim 1, wherein the step of confirming recovery services is performed after at least one of the one or more recovery service providers has submitted a bid via text message, said bid appearing within the electronic platform and being accessible by the new service requester, whereby the new service requester has submitted a counter bid price, which was accepted by the at least one of the one or more recovery service providers.

5. The system of claim 1, wherein the step of confirming recovery services is performed to alert the new service requester of the availability of a recovery service provider of the one or more recovery service providers.

6. The system of claim 1, wherein the step of contacting is performed automatically based upon the information provided by the new service requester.

7. The system of claim 1, wherein the step of confirming recovery services is first performed by a recovery service provider of the one or more recovery service providers providing a confirmation that recovery service can be performed at a particular price and within a particular period of time.

8. The system of claim 1, wherein the one or more remote users are demand users, and wherein the one or more recovery service providers are supply users.

9. A method, comprising:
operating the system of claim 1 to facilitate the recovery services.

10. A system, accessible by one or more remote users via a network, configured to perform various steps of a method based upon execution of software instructions using a processor, said method steps comprising:
providing an electronic platform accessible by one or more remote users, the electronic platform configured to include data relating to one or more demand users and one or more supply users;
entering information relating to a new demand into the electronic platform by a new demand user, the new demand relating to a demanded service;
contacting one or more of the one or more supply users via text message from the electronic platform; and
confirming demanded service in connection with the new demand using the electronic platform.

11. The system of claim 10, wherein the one or more supply users are associated with a region or location, wherein multiple regions or locations are included within the electronic platform.

12. The system of claim 10, wherein the step of confirming demanded services is performed after at least one of the one or more supply users has submitted a bid via text message, said bid appearing within the electronic platform and being accessible by and accepted by the new demand user.

13. The system of claim 10, wherein the step of confirming demanded services is performed after at least one of the one or more supply users has submitted a bid via text message, said bid appearing within the electronic platform and being accessible by the new demand user, whereby the new demand user has submitted a counter bid price, which was accepted by the at least one of the one or more supply users.

14. The system of claim 10, wherein the step of confirming demand services is performed to alert the new demand user of the availability of a supply user of the one or more supply users.

15. The system of claim 10, wherein the step of contacting is performed automatically based upon the information provided by the new demand user.

16. The system of claim 10, wherein the step of confirming demand services is first performed by a supply user of the one or more supply users providing a confirmation that the demanded service can be performed at a particular price and within a particular period of time.

17. A method, comprising:
operating the system of claim 10 to facilitate the demanded service.
